(19) United States
(12) Patent Application Publication
(10) Pub. No.: US 2022/0050977 A1
(43) Pub. Date: Feb. 17, 2022

(54) VEHICLE, CLEANING MANAGEMENT SYSTEM, NON-TRANSITORY COMPUTER READABLE MEDIUM, AND VEHICLE CONTROL METHOD

(71) Applicant: Toyota Jidosha Kabushiki Kaisha, Toyota-shi Aichi-ken (JP)

(72) Inventors: Aya Sato, Miyoshi-shi Aichi-ken (JP); Kuniaki Jinnai, Nagoya-shi Aichi-ken (JP); Kenichi Yamada, Nisshin-shi Aichi-ken (JP); Hiroaki Takeyama, Nagoya-shi Aichi-ken (JP); Taylor Wright, Toyota-shi Aichi-ken (JP); Nutonya L. Parker-Harris, Dallas, TX (US)

(21) Appl. No.: 17/399,497

(22) Filed: Aug. 11, 2021

(30) Foreign Application Priority Data
Aug. 11, 2020 (JP) 2020-136065

(51) Int. Cl. G06K 7/10; H04W 4/44; H04W 4/029; G06F 21/44; G05D 1/02

(52) U.S. Cl. CPC G06K 7/10297; H04W 4/44; G05D 1/0282; G06F 21/44; H04W 4/029

(57) ABSTRACT

A vehicle includes a first space configured to store cleaned clothes, a second space separated from the first space, a conveyance apparatus configured to convey the cleaned clothes from the first space to the second space, a reader configured to read RF tag data from an RF tag attached to the cleaned clothes, and a control apparatus configured to control the conveyance apparatus. The control apparatus is configured to identify, based on the RF tag data read by the reader, clothes subject to delivery that are to be delivered at a next delivery location, and cause only the clothes subject to delivery to be conveyed from the first space to the second space.

### CROSS-REFERENCE TO RELATED APPLICATION

This application claims priority to Japanese Patent Application No. 2020-136065, filed on Aug. 11, 2020, the entire contents of which are incorporated herein by reference.

### TECHNICAL FIELD

The present disclosure relates to a vehicle, a cleaning management system, a program, and a vehicle control method.

### BACKGROUND

To request cleaning of clothes or the like, users typically visit a cleaning shop and speak face-to-face with a clerk of the cleaning shop. When the cleaning is complete, the users typically visit the cleaning shop and speak face-to-face with a clerk of the cleaning shop to receive the cleaned clothes.

However, it is troublesome for users to visit the cleaning shop. Furthermore, since users need to visit the cleaning shop during business hours, there are time constraints on the use of cleaning shops. Thus, visiting a cleaning shop can be inconvenient for the users of the cleaning shop.

To eliminate inconvenience for a user who requests cleaning, patent literature (PTL) 1 discloses an automatic collection apparatus capable of automatically collecting articles for cleaning. If the automatic collection apparatus is installed near the user's home, the user can request cleaning by going to the nearby automatic collection apparatus. Furthermore, since there are no time constraints on the automatic collection apparatus, the user can request cleaning at any time.

### CITATION LIST

### Patent Literature

PTL 1: JP H10-235100 A

### SUMMARY

The automatic collection apparatus described in PTL 1 has a function of collecting clothes but cannot deliver cleaned clothes. It is therefore necessary for a cleaning shop clerk or the like to deliver the cleaned clothes. Hence, the cleaning shop needs to allocate personnel to the delivery of cleaned clothes.

The operation for returning cleaned clothes has room for improvement.

It would be helpful to improve the operation for returning cleaned clothes.

A vehicle according to the present disclosure includes:

a first space configured to store cleaned clothes;

a second space separated from the first space;

a conveyance apparatus configured to convey the cleaned clothes from the first space to the second space;

a reader configured to read RF tag data from an RF tag attached to the cleaned clothes; and

a control apparatus configured to control the conveyance apparatus,

wherein the control apparatus is configured to
identify, based on the RF tag data read by the reader, clothes subject to delivery that are to be delivered at a next delivery location, and
cause only the clothes subject to delivery to be conveyed from the first space to the second space.

A program according to the present disclosure is configured to cause a computer mounted in a vehicle to perform operations, wherein

the vehicle includes:
a first space configured to store cleaned clothes;
a second space separated from the first space;
a conveyance apparatus configured to convey the cleaned clothes from the first space to the second space; and
a reader configured to read RF tag data from an RF tag attached to the cleaned clothes, and

the operations include:
identifying, based on the RF tag data read by the reader, clothes subject to delivery that are to be delivered at a next delivery location; and
causing only the clothes subject to delivery to be conveyed from the first space to the second space.

A vehicle control method according to the present disclosure is a vehicle control method for controlling a vehicle, wherein

the vehicle includes:
a first space configured to store cleaned clothes;
a second space separated from the first space;
a conveyance apparatus configured to convey the cleaned clothes from the first space to the second space; and
a reader configured to read RF tag data from an RF tag attached to the cleaned clothes, and

the vehicle control method includes:
identifying, based on the RF tag data read by the reader, clothes subject to delivery that are to be delivered at a next delivery location; and
causing only the clothes subject to delivery to be conveyed from the first space to the second space.

The present disclosure can improve the operation for returning cleaned clothes.

### BRIEF DESCRIPTION OF THE DRAWINGS

In the accompanying drawings:

FIG. 1 is a diagram illustrating a configuration of a cleaning management system according to an embodiment of the present disclosure;

FIG. 2 is a block diagram illustrating a configuration of an information processing apparatus according to an embodiment of the present disclosure;

FIG. 3 is a block diagram illustrating a configuration of a terminal apparatus according to an embodiment of the present disclosure;

FIG. 4 is a block diagram illustrating a configuration of a vehicle according to an embodiment of the present disclosure;

FIG. 5 is a side view illustrating an example configuration of a vehicle according to an embodiment of the present disclosure;

FIG. 6 is a perspective diagram of an example configuration of the interior of the vehicle of FIG. 5 from above;

FIG. 7 is a sequence diagram illustrating an example of operations of the cleaning management system according to an embodiment of the present disclosure at the time of returning cleaned clothes;

FIG. 8 is a sequence diagram illustrating an example of operations of the cleaning management system according to an embodiment of the present disclosure at the time of collection of pre-cleaning clothes; and

FIG. 9 is a block diagram illustrating a configuration of a vehicle according to a modification of the present disclosure.

### DETAILED DESCRIPTION

Embodiments of the present disclosure are described below with reference to the drawings.

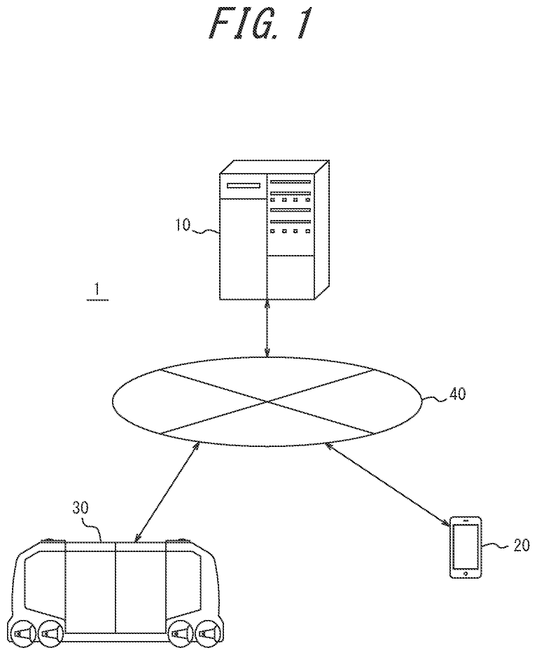

FIG. 1 is a diagram illustrating a configuration of a cleaning management system 1 according to an embodiment of the present disclosure. With reference to FIG. 1, a configuration and outline of the cleaning management system 1 according to an embodiment of the present disclosure are described.

The cleaning management system 1 includes an information processing apparatus 10, a terminal apparatus 20, and a vehicle 30. The information processing apparatus 10, the terminal apparatus 20, and the vehicle 30 are communicably connected via a network 40. The network 40 may be a network including a mobile communication network, the Internet, or the like.

In FIG. 1, one each of the information processing apparatus 10, the terminal apparatus 20, and the vehicle 30 are illustrated, but the number of information processing apparatuses 10, terminal apparatuses 20, and vehicles 30 may be two or more of each.

The information processing apparatus 10 is, for example, a dedicated computer configured to function as a server. The information processing apparatus 10 may be a general purpose personal computer (PC). The information processing apparatus 10 can communicate with the terminal apparatus 20 and the vehicle 30 via the network 40.

The information processing apparatus 10 receives a cleaning request from the terminal apparatus 20 owned by the user requesting cleaning. When cleaning of the clothes collected from the user is complete, the information processing apparatus 10 transmits a notification to the terminal apparatus 20 that cleaning is complete. The “user who requests cleaning” is also simply referred to below as the “user”.

The information processing apparatus 10 manages a travel route of the vehicle 30, which collects pre-cleaning clothes and returns the clothes after cleaning. When pre-cleaning clothes are to be collected from the user, the information processing apparatus 10 determines the travel route of the vehicle 30 to a collection location for collecting the clothes from the user. When cleaned clothes are to be returned to the user, the information processing apparatus 10 determines the travel route of the vehicle 30 to a delivery location for delivering the clothes to the user. After determining the travel route, the information processing apparatus 10 transmits information on the travel route to the vehicle 30. In the case of collecting pre-cleaning clothes, the travel route includes information on the collection location. In the case of returning cleaned clothes, the travel route includes information on the delivery location.

The terminal apparatus 20 is a terminal apparatus owned by the user who requests cleaning. The terminal apparatus 20 may, for example, be a smartphone or tablet. The terminal apparatus 20 can communicate with the information processing apparatus 10 and the vehicle 30 via the network 40.

The vehicle 30 is any appropriate type of automobile, such as a gasoline-powered vehicle, a diesel-powered vehicle, a hybrid vehicle (HV), a plug-in hybrid vehicle (PHV), an electric vehicle (EV), or a fuel cell vehicle (FCV). Driving of the vehicle 30 may be automated at any level. The level of automation is, for example, one of level 1 to level 5 in the level classification of the Society of Automotive Engineers (SAE). The vehicle 30 may be a Mobility as a Service (MaaS) dedicated vehicle. The vehicle 30 can communicate with the information processing apparatus 10 and the terminal apparatus 20 via the network 40.

Upon the vehicle 30 receiving a collection command, from the information processing apparatus 10, that instructs to collect pre-cleaning clothes from the user, the vehicle 30 travels to the collection location according to the travel route included in the collection command. Here, the “collection location” is a location for the vehicle 30 to collect pre-cleaning clothes from the user. Upon arrival at the collection location, the vehicle 30 receives the pre-cleaning clothes from the user and stores the clothes inside the vehicle 30.

Upon the vehicle 30 receiving a delivery command, from the information processing apparatus 10, instructing to deliver the cleaned clothes, the vehicle 30 travels to the delivery location according to the travel route included in the delivery command. Here, the “delivery location” is a location for the vehicle 30 to return cleaned clothes to the user. The vehicle 30 delivers cleaned clothes to the user upon arrival at the delivery location.

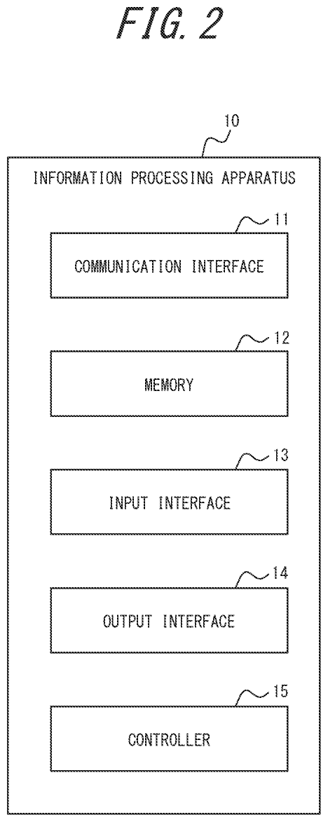

With reference to FIG. 2, the configuration of the information processing apparatus 10 according to an embodiment of the present disclosure is described.

The information processing apparatus 10 includes a communication interface 11, a memory 12, an input interface 13, an output interface 14, and a controller 15.

The communication interface 11 includes a communication module that connects to the network 40. For example, the communication interface 11 may include a communication module compliant with a local area network (LAN). In an embodiment, the information processing apparatus 10 is connected to the network 40 via the communication interface 11. The communication interface 11 transmits and receives various information via the network 40. The communication interface 11 can communicate with the terminal apparatus 20 and the vehicle 30 via the network 40.

The memory 12 is, for example, a semiconductor memory, a magnetic memory, an optical memory, or the like, but is not limited to these. The memory 12 may, for example, function as a main memory, an auxiliary memory, or a cache memory. The memory 12 stores any information used for operations of the information processing apparatus 10. For example, the memory 12 may store a system program, an application program, various types of information received by the communication interface 11, and the like. The information stored in the memory 12 may, for example, be updated with information received from the network 40 via the communication interface 11. A portion of the memory 12 may be installed externally to the information processing apparatus 10. In this case, the externally installed portion of the memory 12 may be connected to the information processing apparatus 10 via any appropriate interface.

The input interface 13 includes one or more interfaces for input to detect user input and acquire input information based on user operations. For example, the input interface 13 includes, but is not limited to, a physical key, a capacitive key, a touch screen integrally provided with a display of the output interface 14, or a microphone that receives audio input.

The output interface 14 includes one or more interfaces for output to output information and notify the user. For example, the output interface 14 includes, but is not limited to, a display for outputting information as images or a speaker for outputting information as audio.

The controller 15 includes at least one processor, at least one dedicated circuit, or a combination thereof. The processor is a general purpose processor, such as a central processing unit (CPU) or a graphics processing unit (GPU), or a dedicated processor specialized for a particular process. The dedicated circuit is, for example, a field-programmable gate array (FPGA) or an application specific integrated circuit (ASIC). The controller 15 executes processing related to operations of the information processing apparatus 10 while controlling each component of the information processing apparatus 10.

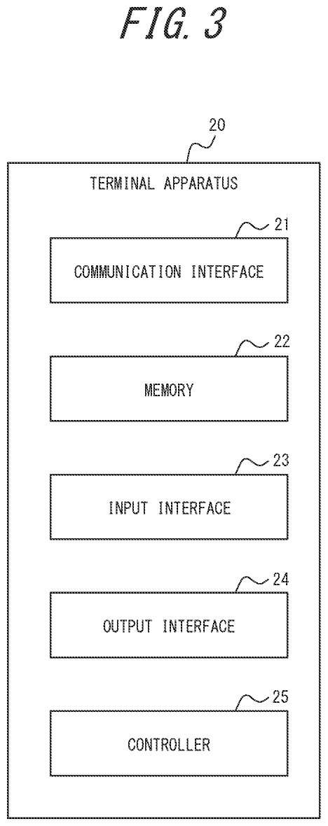

With reference to FIG. 3, the configuration of the terminal apparatus 20 according to an embodiment of the present disclosure is described.

The terminal apparatus 20 includes a communication interface 21, a memory 22, an input interface 23, an output interface 24, and a controller 25.

The communication interface 21 includes a communication module that connects to the network 40. For example, the communication interface 21 may include a communication module compliant with mobile communication standards such as Long Term Evolution (LTE), 4th Generation (4G), and 5th Generation (5G). In an embodiment, the terminal apparatus 20 is connected to the network 40 via the communication interface 21. The communication interface 21 transmits and receives various information via the network 40. The communication interface 21 can communicate with the information processing apparatus 10 and the vehicle 30 via the network 40.

The memory 22 is, for example, a semiconductor memory, a magnetic memory, an optical memory, or the like, but is not limited to these. The memory 22 may, for example, function as a main memory, an auxiliary memory, or a cache memory. The memory 22 stores any information used for operations of the terminal apparatus 20. For example, the memory 22 may store a system program, an application program, various types of information received by the communication interface 21, and the like. The information stored in the memory 22 may, for example, be updated with information received from the network 40 via the communication interface 21. A portion of the memory 22 may be installed externally to the terminal apparatus 20. In this case, the externally installed portion of the memory 22 may be connected to the terminal apparatus 20 via any appropriate interface.

The input interface 23 includes one or more interfaces for input to detect user input and acquire input information based on user operations. For example, the input interface 23 includes, but is not limited to, a physical key, a capacitive key, a touch screen integrally provided with a display of the output interface 24, or a microphone that receives audio input.

The output interface 24 includes one or more interfaces for output to output information and notify the user. For example, the output interface 24 includes, but is not limited to, a display for outputting information as images or a speaker for outputting information as audio.

The controller 25 includes at least one processor, at least one dedicated circuit, or a combination thereof. The processor is a general purpose processor, such as a CPU or GPU, or a dedicated processor specialized for a particular process. The dedicated circuit is, for example, an FPGA or an ASIC. The controller 25 executes processing related to operations of the terminal apparatus 20 while controlling each component of the terminal apparatus 20.

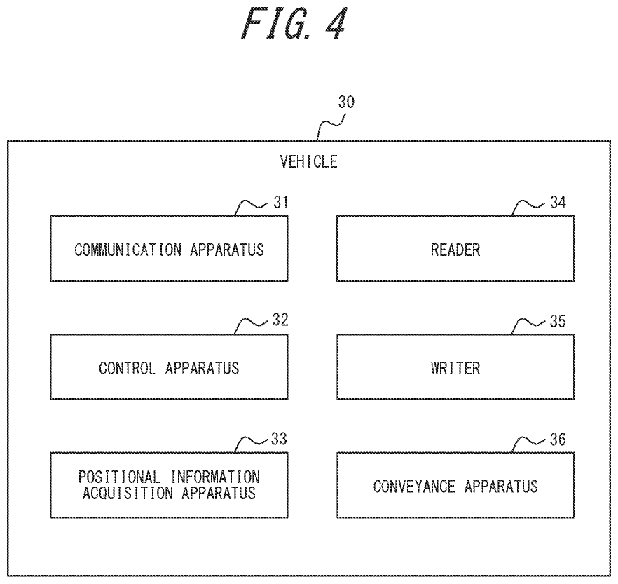

With reference to FIG. 4, the functional blocks of the vehicle 30 according to an embodiment of the present disclosure are described.

The vehicle 30 includes a communication apparatus 31, a control apparatus 32, a positional information acquisition apparatus 33, a reader 34, a writer 35, and a conveyance apparatus 36. The communication apparatus 31, the control apparatus 32, the positional information acquisition apparatus 33, the reader 34, the writer 35, and the conveyance apparatus 36 are, for example, communicably connected to each other via a vehicle-mounted network, such as a controller area network (CAN), or a dedicated line.

The communication apparatus 31 includes a communication module that connects to the network 40. For example, the communication apparatus 31 may include a communication module compliant with a mobile communication standard such as LTE, 4G, and 5G. In an embodiment, the vehicle 30 is connected to the network 40 via the communication apparatus 31. The communication apparatus 31 transmits and receives various information via the network 40. The communication apparatus 31 can communicate with the information processing apparatus 10 and the terminal apparatus 20 via the network 40.

The communication apparatus 31 includes a communication module, for example, compliant with a short-range wireless communication standard such as Wi-Fi® (Wi-Fi is a registered trademark in Japan, other countries, or both), Bluetooth® (Bluetooth is a registered trademark in Japan, other countries, or both), or infrared communication. The communication apparatus 31 can communicate with the terminal apparatus 20 via short-range wireless communication.

The control apparatus 32 includes at least one processor, at least one dedicated circuit, or a combination thereof. The processor is a general purpose processor, such as a CPU or GPU, or a dedicated processor specialized for a particular process. The dedicated circuit is, for example, an FPGA or an ASIC. The control apparatus 32 executes processing related to operations of the vehicle 30 while controlling each component of the vehicle 30.

The positional information acquisition apparatus 33 includes one or more receivers compliant with any appropriate satellite positioning system. For example, the positional information acquisition apparatus 33 may include a global positioning system (GPS) receiver. The positional information acquisition apparatus 33 acquires the measured position of the vehicle 30 as positional information. The positional information includes, for example, an address, latitude, longitude, altitude, and the like.

The reader 34 is mounted in a storage space 54 of the vehicle 30, described below with reference to FIG. 6. The reader 34 can read radio frequency (RF) tag data from an RF tag attached to the clothes stored in the storage space 54. Here, the RF tag data is data written to the RF tag. Details of the RF tag data are described below.

The writer 35 is installed in the vehicle 30. The writer 35 can write data to the RF tag. The RF tag with data written thereon is attached to the clothes by the user when the vehicle 30 collects the pre-cleaning clothes from the user. The writer 35 can receive an operation by a user who intends to hand over pre-cleaning clothes.

The conveyance apparatus 36 is installed in the vehicle 30. The conveyance apparatus 36 can convey the cleaned clothes, stored in the storage space 54 illustrated in FIG. 6, from the storage space 54 to a delivery space 55 illustrated in FIG. 6. The conveyance apparatus 36 may include any appropriate conveyance mechanism capable of conveying clothes. The conveyance apparatus 36 may, for example, include rails capable of conveying clothes hung on a hanger together with the hanger.

The conveyance apparatus 36 may also convey pre-cleaning clothes, received from the user in the delivery space 55 illustrated in FIG. 6, from the delivery space 55 to the storage space 54.

(Vehicle Configuration)

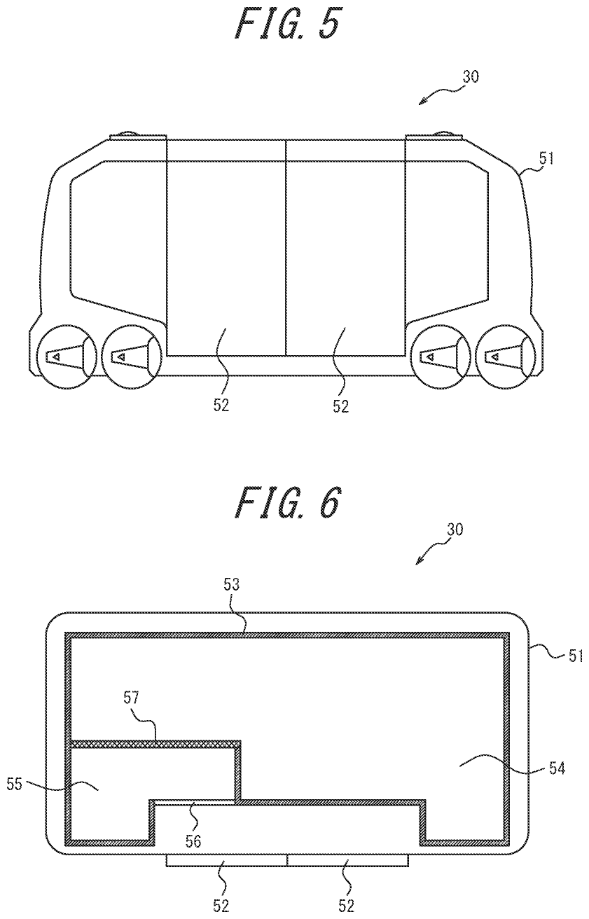

Next, with reference to FIGS. 5 and 6, the configuration of the vehicle 30 is described. FIG. 5 is a side view illustrating an example configuration of the vehicle 30. FIG. 6 is a perspective diagram of an example configuration of the interior of the vehicle 30 from above. FIGS. 5 and 6 conceptually illustrate the configuration of the vehicle 30. The dimension ratios of the drawings differ from the ratios of the actual vehicle 30 configuration.

As illustrated in FIG. 5, the vehicle 30 includes a body 51 and a door 52. The door 52 is openable and closable. The door 52 may be opened and closed in various manners such as by sliding or folding. The vehicle 30 opens the door 52 when collecting pre-cleaning clothes from the user. The vehicle 30 opens the door 52 when returning cleaned clothes to the user.

Locking and unlocking of the door 52 is controlled by the control apparatus 32 illustrated in FIG. 4. The control apparatus 32 performs an authentication process with the terminal apparatus 20 of the user when receiving the pre-cleaning clothes from the user. The control apparatus 32 performs the authentication process with the terminal apparatus 20 of the user when delivering the cleaned clothes to the user. When the authentication process is successful, the control apparatus 32 unlocks the door 52 and allows the user access to the delivery space 55. The control apparatus 32 may, for example, communicate with the terminal apparatus 20 of the user by short-range wireless communication via the communication apparatus 31 illustrated in FIG. 4 to perform the authentication process with the terminal apparatus 20.

As illustrated in FIG. 6, the vehicle 30 includes the storage space 54 and the delivery space 55. The storage space 54 and the delivery space 55 are each surrounded by a surrounding wall 53. The storage space 54 corresponds to the “first space” recited in the claims. The delivery space 55 corresponds to the “second space” recited in the claims.

The storage space 54 is a space configured to store cleaned clothes. The storage space 54 stores the cleaned clothes when the vehicle 30 travels to the delivery location to return the cleaned clothes to the user. If the vehicle 30 is returning cleaned clothes to a plurality of users, the storage space 54 stores the cleaned clothes of the plurality of users.

The storage space 54 can also store pre-cleaning clothes. The storage space 54 stores pre-cleaning clothes collected from the user at the delivery location.

The delivery space 55 is separated from the storage space 54 by the surrounding wall 53 and a partition plate 57. Furthermore, a delivery door 56 is installed in the surrounding wall 53 near the door 52 of the delivery space 55.

The delivery door 56 is a door for the user to access the delivery space 55 when handing over cleaned clothes to the user. The user enters the delivery space 55 through the delivery door 56 when receiving the cleaned clothes.

The delivery door 56 may be lockable. In this case, the control apparatus 32 performs the authentication process with the terminal apparatus 20 of the user, and when the authentication process is successful, the control apparatus 32 unlocks the delivery door 56.

The partition plate 57 separates the delivery space 55 from the storage space 54. The partition plate 57 is openable and closable. The opening and closing of the partition plate 57 is controlled by the control apparatus 32. The partition plate 57 is normally closed. The control apparatus 32 opens the partition plate 57 when conveying cleaned clothes from the storage space 54 to the delivery space 55. The control apparatus 32 also opens the partition plate 57 when conveying pre-cleaning clothes from the delivery space 55 to the storage space 54.

(Operations when Cleaned Clothes are Returned)

Operations of the cleaning management system 1 when cleaned clothes are returned to the user who requested cleaning are described with reference to FIGS. 1 to 6.

The communication interface 11 of the information processing apparatus 10 receives a notification, from the cleaning plant entrusted with the cleaning of clothes collected from the user, indicating that the cleaning is complete. Upon acquiring the notification that the cleaning is complete via the communication interface 11, the controller 15 of the information processing apparatus 10 transmits a candidate time, for delivery of the cleaned clothes to the user, to the terminal apparatus 20 via the communication interface 11. The controller 15 may transmit one candidate time or a plurality of candidate times.

The communication interface 21 of the terminal apparatus 20 receives, from the information processing apparatus 10, the candidate time for receiving the cleaned clothes from the vehicle 30. Upon acquiring, via the communication interface 21, the candidate time for receiving the cleaned clothes from the vehicle 30, the controller 25 of the terminal apparatus 20 displays the candidate time on the output interface 24.

The input interface 23 of the terminal apparatus 20 receives a selection by the user for the candidate time displayed on the output interface 24. The controller 25 of the terminal apparatus 20 transmits the candidate time selected by the user to the information processing apparatus 10 via the communication interface 21.

The controller 15 of the information processing apparatus 10 acquires the candidate time selected by the user via the communication interface 11. Based on the candidate time selected by the user, the controller 15 determines when the vehicle 30 will arrive at the delivery location to return the cleaned clothes to the user.

Upon determining when the vehicle 30 will arrive at the delivery location, the controller 15 transmits an authentication code to the terminal apparatus 20 and the vehicle 30. The authentication code is used for an authentication process when cleaned clothes are to be received by the user from the vehicle 30 at the delivery location.

Upon determining when the vehicle 30 will arrive at the delivery location, the controller 15 determines a travel route for the vehicle 30 to go to the delivery location. When cleaned clothes are to be returned to a plurality of users, the controller 15 may determine the travel route based on the time of arrival at the delivery locations for the respective users.

Upon determining the travel route, the controller 15 transmits information on the travel route to the vehicle 30 via the communication interface 11.

The communication apparatus 31 of the vehicle 30 receives, from the information processing apparatus 10, the information on the travel route for going to the delivery location. Upon acquiring, via the communication apparatus 31, the information on the travel route for going to the delivery location, the control apparatus 32 of the vehicle 30 causes the vehicle 30 to travel to the delivery location. At this time, the control apparatus 32 may cause the vehicle 30 to travel by autonomous driving. The vehicle 30 first goes to the cleaning plant, prior to going to the delivery location, and stores the cleaned clothes in the storage space 54. The operation of loading cleaned clothes into the storage space 54 may be performed by a cleaning plant employee.

During travel to the delivery location, the reader 34 of the vehicle 30 reads the RF tag data from the RF tag attached to the cleaned clothes stored in the storage space 54. The RF tag is attached to the clothes by the user at the time the user hands over the pre-cleaning clothes.

The data written to the RF tag includes data that identifies the user who requested cleaning and data on the delivery location for returning the clothes. The data written to the RF tag may also include data on the type of clothes, data on the cleaning method for the clothes, and the like. Use of the wrong cleaning method to clean the clothes can be avoided if the RF tag contains data on the cleaning method.

The control apparatus 32 of the vehicle 30 identifies, based on the RF tag data read by the reader 34, clothes to be delivered at the delivery location arrived at next by the vehicle 30. The “clothes to be delivered at the delivery location arrived at next” may be referred to below as “clothes subject to delivery”.

Upon identifying the clothes subject to delivery, the control apparatus 32 controls the conveyance apparatus 36 to convey only the clothes subject to delivery from the storage space 54 to the delivery space 55. At this time, the control apparatus 32 opens the partition plate 57. The conveyance apparatus 36 can thereby convey the clothes subject to delivery from the storage space 54 to the delivery space 55. Upon completion of the conveyance of the clothes subject to delivery to the delivery space 55 from the storage space 54, the control apparatus 32 closes the partition plate 57.

When the vehicle 30 arrives at the delivery location, the control apparatus 32 of the vehicle 30 performs the authentication process at the delivery location with the terminal apparatus 20 of the user scheduled to receive the cleaned clothes subject to delivery. The control apparatus 32 and the terminal apparatus 20 perform the authentication process using the authentication code acquired from the information processing apparatus 10.

When the authentication process is successful, the control apparatus 32 unlocks the door 52 of the vehicle 30 and allows the user access to the delivery space 55.

The user can enter the interior of the vehicle 30 once the door 52 is unlocked. Upon entering the interior of the vehicle 30, the user opens the delivery door 56, enters the delivery space 55, and takes the cleaned clothes. At this time, since only the clothes for which the user requested cleaning are stored in the delivery space 55, the user can be prevented from accidentally taking the clothes of another user.

The control apparatus 32 may control the user's access to the delivery space 55 using the delivery door 56. In this case, the delivery door 56 is a lockable door. When the authentication process is successful, the control apparatus 32 unlocks the delivery door 56 and allows the user access to the delivery space 55.

The control apparatus 32 may control the user's access to the delivery space 55 using both the door 52 and the delivery door 56. In this case, when the authentication process is successful, the control apparatus 32 unlocks both the door 52 of the vehicle 30 and the delivery door 56 and allows the user access to the delivery space 55.

Upon identifying the clothes subject to delivery, the control apparatus 32 causes only the clothes subject to delivery to be conveyed from the storage space 54 to the delivery space 55, but the control apparatus 32 may cause the clothes subject to delivery to be conveyed from the storage space 54 to the delivery space 55 at various timings.

For example, the control apparatus 32 may cause only the clothes subject to delivery to be conveyed from the storage space 54 to the delivery space 55 while the vehicle 30 is traveling to the delivery location. The control apparatus 32 may, for example, instead cause only the clothes subject to delivery to be conveyed from the storage space 54 to the delivery space 55 when the vehicle 30 arrives at the delivery location. Alternatively, the control apparatus 32 may, for example, cause only the clothes subject to delivery to be conveyed from the storage space 54 to the delivery space 55 if the vehicle 30 arrives at the delivery location and the authentication process with the terminal apparatus 20 is successful.

(Operations at Time of Collection of Pre-Cleaning Clothes)

Operations of the cleaning management system 1 when pre-cleaning clothes are collected from the user who requested cleaning are described with reference to FIGS. 1 to 6.

Upon receiving input to the input interface 23 from the user requesting cleaning, the controller 25 of the terminal apparatus 20 transmits the received cleaning request to the information processing apparatus 10 via the communication interface 21.

The communication interface 11 of the information processing apparatus 10 receives the cleaning request from the user. Upon acquiring the cleaning request from the user via the communication interface 11, the controller 15 of the information processing apparatus 10 transmits a candidate time for collecting the pre-cleaning clothes from the user to the terminal apparatus 20 via the communication interface 11. The controller 15 may transmit one candidate time or a plurality of candidate times.

The communication interface 21 of the terminal apparatus 20 receives, from the information processing apparatus 10, the candidate time for handing over the pre-cleaning clothes to the vehicle 30. Upon acquiring, via the communication interface 21, the candidate time for handing over the pre-cleaning clothes to the vehicle 30, the controller 25 of the terminal apparatus 20 displays the candidate time on the output interface 24.

The input interface 23 of the terminal apparatus 20 receives a selection by the user for the candidate time displayed on the output interface 24. The controller 25 of the terminal apparatus 20 transmits the candidate time selected by the user to the information processing apparatus 10 via the communication interface 21.

The controller 15 of the information processing apparatus 10 acquires the candidate time selected by the user via the communication interface 11. Based on the candidate time selected by the user, the controller 15 determines when the vehicle 30 will arrive at the collection location to collect the pre-cleaning clothes from the user.

Upon determining when the vehicle 30 will arrive at the collection location, the controller 15 transmits an authentication code to the terminal apparatus 20 and the vehicle 30. The authentication code is used for an authentication process when pre-cleaning clothes are to be handed over by the user to the vehicle 30 at the collection location.

Upon determining when the vehicle 30 will arrive at the collection location, the controller 15 determines a travel route for the vehicle 30 to go to the collection location. When pre-cleaning clothes are to be collected from a plurality of users, the controller 15 may determine the travel route based on the time of arrival at the collection locations for the respective users.

Upon determining the travel route, the controller 15 transmits information on the travel route to the vehicle 30 via the communication interface 11.

The communication apparatus 31 of the vehicle 30 receives, from the information processing apparatus 10, the information on the travel route for going to the collection location. Upon acquiring, via the communication apparatus 31, the information on the travel route for going to the collection location, the control apparatus 32 of the vehicle 30 causes the vehicle 30 to travel to the collection location. At this time, the control apparatus 32 may cause the vehicle 30 to travel by autonomous driving.

When the vehicle 30 arrives at the collection location, the control apparatus 32 of the vehicle 30 performs the authentication process with the terminal apparatus 20 of the user at the collection location. The control apparatus 32 and the terminal apparatus 20 perform the authentication process using the authentication code acquired from the information processing apparatus 10.

When the authentication process is successful, the control apparatus 32 unlocks the door 52 of the vehicle 30 and allows the user access to the delivery space 55.

The user can enter the interior of the vehicle 30 once the door 52 is unlocked. Inside the vehicle 30 is an RF tag for attachment to the pre-cleaning clothes. The writer 35 of the vehicle 30 receives an operation by the user and writes data to the RF tag. Data that identifies the user who requested cleaning and data on the delivery location for returning the clothes are written to the RF tag. Furthermore, data on the type of clothes, data on the cleaning method for the clothes, and the like may be written to the RF tag.

The user attaches an RF tag to each pre-cleaning clothes item. The user may attach the RF tag by any appropriate method. For example, the user may attach the RF tag using a clip.

Once the RF tag is attached to each pre-cleaning clothes item, the user opens the delivery door 56, enters the delivery space 55, and hands over the pre-cleaning clothes. At this time, clothes of other users are not stored in the delivery space 55.

After the pre-cleaning clothes are stored in the delivery space 55, the control apparatus 32 controls the conveyance apparatus 36 to convey the pre-cleaning clothes from the delivery space 55 to the storage space 54.

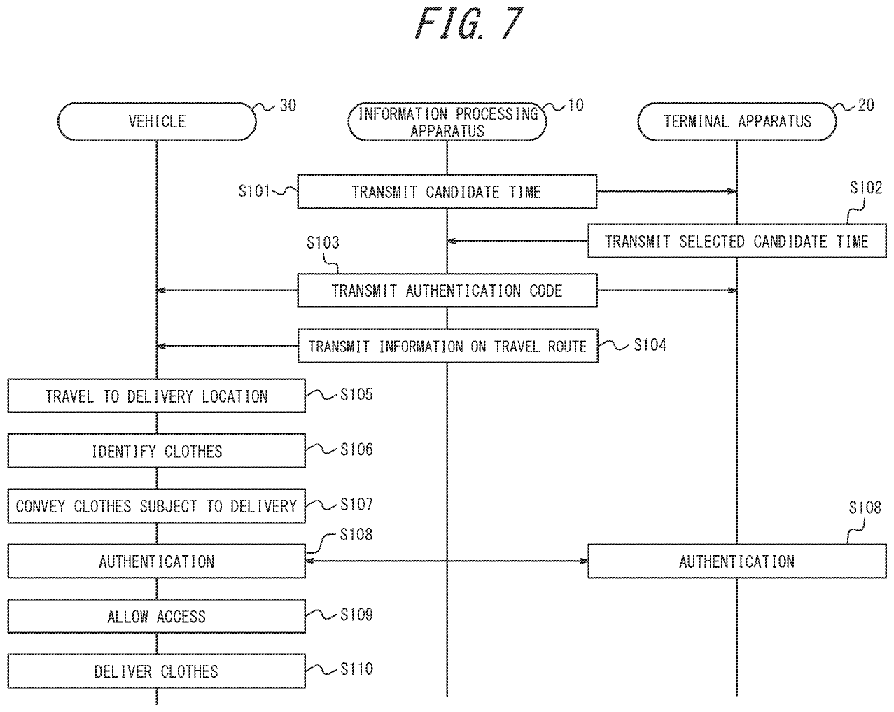

With reference to the sequence diagram illustrated in FIG. 7, an example of operations of the cleaning management system 1 at the time of returning the cleaned clothes is described.

In step S101, upon acquiring a notification from the cleaning plant that the cleaning is complete, the controller 15 of the information processing apparatus 10 transmits a candidate time, for delivery of the cleaned clothes to the user, to the terminal apparatus 20.

In step S102, the controller 25 of the terminal apparatus 20 transmits the candidate time selected by the user, from among candidate times displayed on the output interface 24, to the information processing apparatus 10.

In step S102, if there is no compatible candidate time among the candidate times displayed on the output interface 24, the controller 25 of the terminal apparatus 20 transmits an indication that there is no compatible candidate time to the information processing apparatus 10. In this case, the controller 15 of the information processing apparatus 10 transmits an alternative candidate time to the terminal apparatus 20. The information processing apparatus 10 and the terminal apparatus 20 repeat the processing of steps S101 to S102 until the user selects a compatible candidate time and the terminal apparatus 20 transmits the candidate time to the information processing apparatus 10.

In step S103, based on the candidate time selected by the user, the controller 15 of the information processing apparatus 10 determines when the vehicle 30 will arrive at the delivery location to return the cleaned clothes to the user. Upon determining when the vehicle 30 will arrive at the delivery location, the controller 15 transmits an authentication code to the terminal apparatus 20 and the vehicle 30.

In step S104, the controller 15 determines the travel route for the vehicle 30 to go to the delivery location and transmits information on the determined travel route to the vehicle 30.

In step S105, the control apparatus 32 of the vehicle 30 causes the vehicle 30 to travel toward the delivery location based on the information on the travel route acquired from the information processing apparatus 10.

In step S106, the reader 34 of the vehicle 30 reads the RF tag data from the RF tag attached to the cleaned clothes. The control apparatus 32 of the vehicle 30 identifies, based on the RF tag data read by the reader 34, clothes to be delivered at the delivery location arrived at next by the vehicle 30.

In step S107, the control apparatus 32 of the vehicle 30 controls the conveyance apparatus 36 to convey only the clothes subject to delivery from the storage space 54 to the delivery space 55.

In step S108, when the vehicle 30 arrives at the delivery location, the control apparatus 32 of the vehicle 30 performs the authentication process at the delivery location with the terminal apparatus 20 of the user scheduled to receive the cleaned clothes subject to delivery.

In step S109, when the authentication process is successful, the control apparatus 32 of the vehicle 30 unlocks the door 52 of the vehicle 30 and allows the user access to the delivery space 55.

In step S110, upon entering the interior of the vehicle 30, the user opens the delivery door 56, enters the delivery space 55, and takes the cleaned clothes. That is, the vehicle 30 delivers the cleaned clothes to the user.

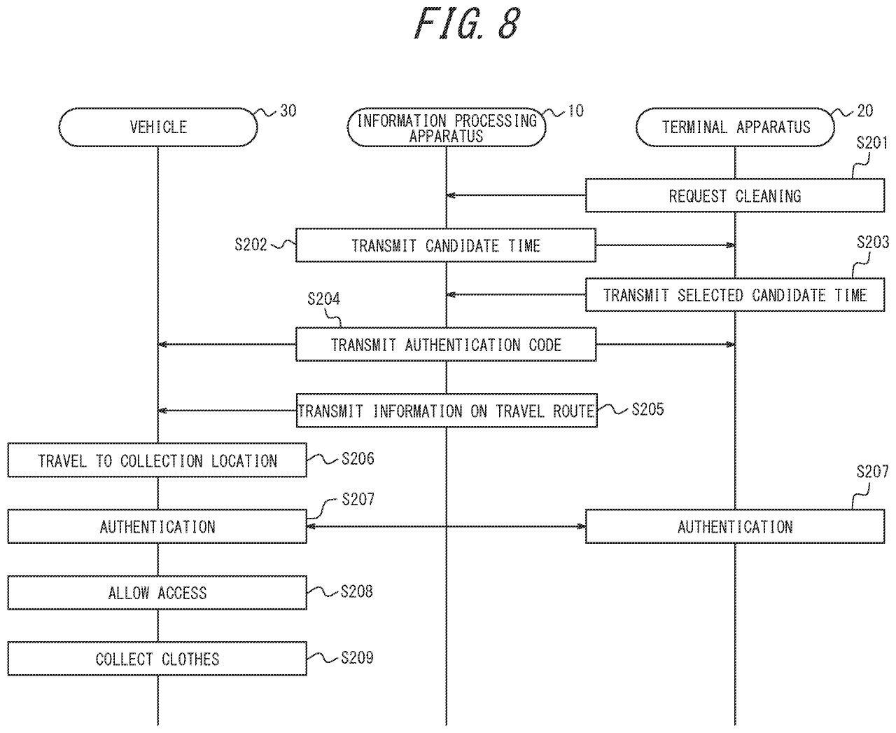

With reference to the sequence diagram illustrated in FIG. 8, an example of operations of the cleaning management system 1 at the time of collection of pre-cleaning clothes is described.

In step S201, upon receiving input to the input interface 23 from the user requesting cleaning, the controller 25 of the terminal apparatus 20 transmits the received cleaning request to the information processing apparatus 10. The cleaning request includes information on clothes for which cleaning is requested, information on the collection location for collection of pre-cleaning clothes, and the like.

In step S202, the controller 15 of the information processing apparatus 10 transmits a candidate time, to the terminal apparatus 20, for collection of pre-cleaning clothes from the user.

In step S203, the controller 25 of the terminal apparatus 20 transmits the candidate time selected by the user, from among candidate times displayed on the output interface 24, to the information processing apparatus 10.

In step S203, if there is no compatible candidate time among the candidate times displayed on the output interface 24, the controller 25 of the terminal apparatus 20 transmits an indication that there is no compatible candidate time to the information processing apparatus 10. In this case, the controller 15 of the information processing apparatus 10 transmits an alternative candidate time to the terminal apparatus 20. The information processing apparatus 10 and the terminal apparatus 20 repeat the processing of steps S202 to S203 until the user selects a compatible candidate time and the terminal apparatus 20 transmits the candidate time to the information processing apparatus 10.

In step S204, based on the candidate time selected by the user, the controller 15 of the information processing apparatus 10 determines when the vehicle 30 will arrive at the collection location to collect the pre-cleaning clothes from the user. Upon determining when the vehicle 30 will arrive at the collection location, the controller 15 transmits an authentication code to the terminal apparatus 20 and the vehicle 30.

In step S205, the controller 15 of the information processing apparatus 10 determines the travel route for the vehicle 30 to go to the collection location and transmits information on the determined travel route to the vehicle 30.

In step S206, the control apparatus 32 of the vehicle 30 causes the vehicle 30 to travel to the collection location based on the information on the travel route acquired from the information processing apparatus 10.

In step S207, when the vehicle 30 arrives at the collection location, the control apparatus 32 of the vehicle 30 performs the authentication process with the terminal apparatus 20 of the user at the collection location.

In step S208, when the authentication process is successful, the control apparatus 32 of the vehicle 30 unlocks the door 52 of the vehicle 30 and allows the user access to the delivery space 55.

In step S209, upon entering the interior of the vehicle 30, the user opens the delivery door 56, enters the delivery space 55, and hands over the pre-cleaning clothes. That is, the vehicle 30 collects the pre-cleaning clothes from the user. At this time, the user operates the writer 35 to write data to the RF tag. The user attaches an RF tag with data written thereon to each of the pre-cleaning clothes.

(Modification)

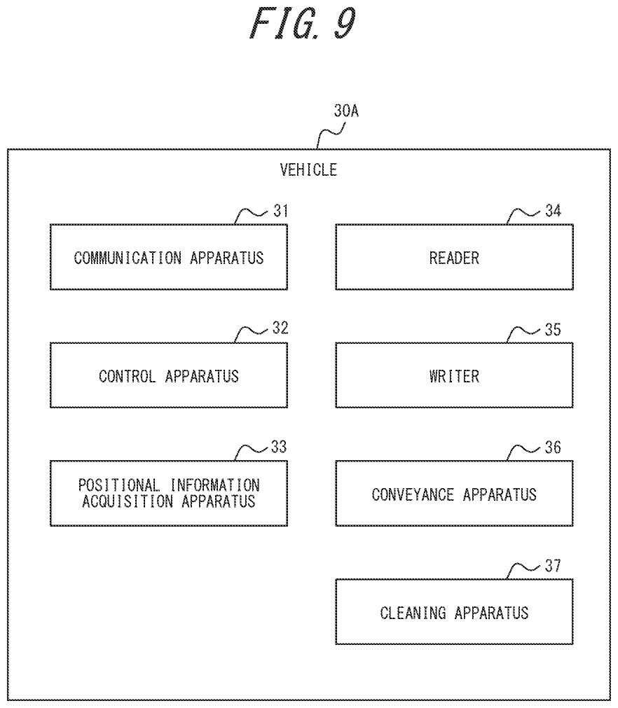

FIG. 9 is a diagram illustrating a configuration of a vehicle 30A according to a modification of the present disclosure. Differences between the vehicle 30A according to the modification and the vehicle 30 described with reference to FIG. 4 are mainly described, whereas a description of similarities is omitted as appropriate.

As illustrated in FIG. 9, the vehicle 30A according to the modification includes the communication apparatus 31, the control apparatus 32, the positional information acquisition apparatus 33, the reader 34, the writer 35, the conveyance apparatus 36, and a cleaning apparatus 37. The vehicle 30A according to the modification differs from the vehicle 30 illustrated in FIG. 4 by including the cleaning apparatus 37.

The cleaning apparatus 37 can perform at least one type of cleaning. The cleaning apparatus 37 can, for example, perform dry cleaning, wet cleaning, and/or laundry cleaning.

Since the vehicle 30A can use the cleaning apparatus 37 to clean the clothes collected from the user, there is no need to entrust the cleaning of clothes to a cleaning plant, unlike with the vehicle 30 illustrated in FIG. 4. Therefore, the time until the collected clothes are cleaned and returned to the user is shorter with the vehicle 30A than with the vehicle 30 illustrated in FIG. 4.

When pre-cleaning clothes are collected from the user, the reader 34 reads the data of the RF tag attached to the pre-cleaning clothes. Based on the data of the cleaning method included in the RF tag data, the control apparatus 32 judges whether the cleaning method of the clothes to which the RF tag is attached is a cleaning method that the cleaning apparatus 37 supports. If the cleaning method is not supported by the cleaning apparatus 37, the control apparatus 32 transmits a message to the terminal apparatus 20 of the user, via the communication apparatus 31, indicating that the cleaning request cannot be received because the cleaning method of the clothes is not supported.

When collecting pre-cleaning clothes from the user, the control apparatus 32 estimates the end time when cleaning of the collected clothes will be complete based on the current operation schedule of the cleaning apparatus 37. The control apparatus 32 transmits the estimated end time to the terminal apparatus 20 of the user via the communication apparatus 31.

The control apparatus 32 causes the cleaning apparatus 37 to begin cleaning when more than a predetermined amount of clothes is stored. Here, the predetermined amount is an amount set for the cleaning apparatus 37 to operate efficiently and may be a preset value. When receiving a request for high-speed cleaning from the terminal apparatus 20 of the user, the control apparatus 32 may cause the cleaning apparatus 37 to begin cleaning prior to storing more than the predetermined amount of clothes. In this case, the control apparatus 32 may transmit a message indicating that the fee for high-speed cleaning is higher than the normal fee to the terminal apparatus 20 of the user via the communication apparatus 31.

As described above, the vehicle 30 according to the present embodiment includes the storage space 54 configured to store the cleaned clothes and the delivery space 55 that is separated from the storage space 54. When returning cleaned clothes, the control apparatus 32 of the vehicle 30 identifies, based on the RF tag data read by the reader 34, clothes subject to delivery that are to be delivered at the next delivery location, and causes only the clothes subject to delivery to be conveyed from the storage space 54 to the delivery space 55. Thus, when returning the cleaned clothes, the vehicle 30 according to the present embodiment can convey the cleaned clothes so that only the clothes subject to delivery are stored in the delivery space 55. This enables the cleaned clothes to be delivered to the user without error. Therefore, the vehicle 30 according to the present embodiment can improve the operation for returning cleaned clothes.

Furthermore, since the vehicle 30 can deliver cleaned clothes to the user without error even during autonomous driving, the vehicle 30 according to the present embodiment can reduce the number of employees required for delivering the cleaned clothes.

The present disclosure is not limited to the above-described embodiments. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, some processing operations performed in the information processing apparatus 10 in the above-described embodiment may be performed in the vehicle 30. At least a portion of the processing operations performed in the vehicle 30 may be performed in the information processing apparatus 10.

For example, the information processing apparatus 10 according to the above-described embodiment may be mounted in the vehicle 30.

For example, a general purpose electronic device, such as a computer, can also be configured to function as the information processing apparatus 10 according to the above-described embodiment. Specifically, a program describing the processing content for realizing the functions of the information processing apparatus 10 and the like according to the embodiment can be stored in a memory of the electronic device, and the program can be read and executed by the processor of the electronic device. Accordingly, the present disclosure can also be embodied as a program executable by a processor.

For example, a general purpose electronic device, such as a computer, can also be configured to function as the control apparatus 32 of the vehicle 30 according to the above-described embodiment. Specifically, a program describing the processing content for realizing the functions of the control apparatus 32 and the like according to the embodiment can be stored in a memory of the electronic device, and the program can be read and executed by the processor of the electronic device. Accordingly, the present disclosure can also be embodied as a program executable by a processor.

For example, in the above-described embodiment, the user attaches an RF tag to the pre-cleaning clothes when handing over the clothes, but the RF tag may be embedded in the clothes.

For example, in the above-described embodiment, an RF tag is attached to clothes, but a bar code or printed matter with a two-dimensional code printed thereon may be attached to the clothes instead of an RF tag.

For example, in the above-described embodiment, driving of the vehicle 30 is assumed to be automated, but a driver may drive the vehicle 30.

1. A vehicle comprising:
a first space configured to store cleaned clothes;
a second space separated from the first space;
a conveyance apparatus configured to convey the cleaned clothes from the first space to the second space;
a reader configured to read RF tag data from an RF tag attached to the cleaned clothes; and
a control apparatus configured to control the conveyance apparatus,
wherein the control apparatus is configured to
identify, based on the RF tag data read by the reader, clothes subject to delivery that are to be delivered at a next delivery location, and
cause only the clothes subject to delivery to be conveyed from the first space to the second space.

2. The vehicle of claim 1, wherein the control apparatus is configured to
perform an authentication process with a terminal apparatus of a user scheduled to receive the clothes subject to delivery at the delivery location, and
allow access by the user to the second space when the authentication process is successful.

3. The vehicle of claim 1, wherein the control apparatus is configured to cause the clothes subject to delivery to be conveyed from the first space to the second space when the vehicle arrives at the delivery location.

4. The vehicle of claim 2, wherein the control apparatus is configured to cause the clothes subject to delivery to be conveyed from the first space to the second space when the authentication process is successful.

5. The vehicle of claim 1, wherein the RF tag data includes data identifying a user requesting cleaning of clothes to which the RF tag is attached and data on a delivery location of the clothes to which the RF tag is attached.

6. The vehicle of claim 1, wherein the control apparatus is configured to communicate with an information processing apparatus configured to manage a travel route of the vehicle.

7. The vehicle of claim 6, wherein the control apparatus is configured to acquire information on the delivery location from the information processing apparatus.

8. A cleaning management system comprising:
the vehicle of claim 1; and
an information processing apparatus configured to manage a travel route of the vehicle.

9. A non-transitory computer readable medium storing a program configured to cause a computer mounted in a vehicle to perform operations, wherein
the vehicle comprises:
a first space configured to store cleaned clothes;
a second space separated from the first space;
a conveyance apparatus configured to convey the cleaned clothes from the first space to the second space; and
a reader configured to read RF tag data from an RF tag attached to the cleaned clothes, and
the operations comprise:
identifying, based on the RF tag data read by the reader, clothes subject to delivery that are to be delivered at a next delivery location; and
causing only the clothes subject to delivery to be conveyed from the first space to the second space.

10. The non-transitory computer readable medium of claim 9, wherein the operations further comprise:
performing an authentication process with a terminal apparatus of a user scheduled to receive the clothes subject to delivery at the delivery location; and
allowing access by the user to the second space when the authentication process is successful.

11. The non-transitory computer readable medium of claim 9, wherein the causing the clothes subject to delivery to be conveyed includes causing the clothes subject to delivery to be conveyed from the first space to the second space when the vehicle arrives at the delivery location.

12. The non-transitory computer readable medium of claim 10, wherein the causing the clothes subject to delivery to be conveyed includes causing the clothes subject to delivery to be conveyed from the first space to the second space when the authentication process is successful.

13. The non-transitory computer readable medium of claim 9, wherein the RF tag data includes data identifying a user requesting cleaning of clothes to which the RF tag is attached and data on a delivery location of the clothes to which the RF tag is attached.

14. The non-transitory computer readable medium of claim 9, wherein the computer is configured to communicate with an information processing apparatus configured to manage a travel route of the vehicle.

15. A vehicle control method for controlling a vehicle, wherein
the vehicle comprises:
a first space configured to store cleaned clothes;
a second space separated from the first space;
a conveyance apparatus configured to convey the cleaned clothes from the first space to the second space; and
a reader configured to read RF tag data from an RF tag attached to the cleaned clothes, and
the vehicle control method comprises:
identifying, based on the RF tag data read by the reader, clothes subject to delivery that are to be delivered at a next delivery location; and
causing only the clothes subject to delivery to be conveyed from the first space to the second space.

16. The vehicle control method of claim 15, further comprising:
performing an authentication process with a terminal apparatus of a user scheduled to receive the clothes subject to delivery at the delivery location; and
allowing access by the user to the second space when the authentication process is successful.

17. The vehicle control method of claim 15, wherein the causing the clothes subject to delivery to be conveyed includes causing the clothes subject to delivery to be conveyed from the first space to the second space when the vehicle arrives at the delivery location.

18. The vehicle control method of claim 16, wherein the causing the clothes subject to delivery to be conveyed includes causing the clothes subject to delivery to be conveyed from the first space to the second space when the authentication process is successful.

19. The vehicle control method of claim 15, wherein the RF tag data includes data identifying a user requesting cleaning of clothes to which the RF tag is attached and data on a delivery location of the clothes to which the RF tag is attached.

20. The vehicle control method of claim 15, wherein the vehicle is configured to communicate with an information processing apparatus configured to manage a travel route of the vehicle.
